(19) United States
(12) Patent Application Publication
(10) Pub. No.: US 2011/0279737 A1
(43) Pub. Date: Nov. 17, 2011

(54) LIGHTING DEVICE FOR DISPLAY DEVICE, DISPLAY DEVICE, AND TELEVISION RECEIVER

(75) Inventor: Yasumori Kuromizu, Osaka-shi (JP)

(73) Assignee: SHARP KABUSHIKI KAISHA, Osaka-shi, Osaka (JP)

(21) Appl. No.: 13/145,568

(22) PCT Filed: Nov. 10, 2009
(86) PCT No.: PCT/JP2009/069093

§ 371 Date: Jul. 21, 2011

(30) Foreign Application Priority Data
Feb. 12, 2009 (JP) 2009-030038

(51) Int. Cl. H04N 5/66; G02F 1/1335; G02F 1/13357

(52) U.S. Cl. 348/739; 362/97.1; 349/61; 348/E05.133

(57) ABSTRACT

A lighting device includes: discharge tubes 17 disposed in parallel arrangement; a support member 151 supporting ends of the discharge tubes 17; connecting terminals 152 arranged on the support member 151 and in an arrangement direction in which the discharge tubes 17 are disposed, the connecting terminals 152 holding the discharge tubes 17 individually and function as terminals to supply drive power; and balancing components 56 that balance currents to be fed to the connecting terminals 152, the balancing components 56 connected between a power source 170 and the respective connecting terminals 152. An outer balancing component 56a corresponds to an outermost connecting terminal 152 and is disposed on the support member 151 and outer in the arrangement direction than a bend line 14b provided inside a chassis 14. The other balancing components 56b are disposed on the support member 151 and adjacent to the respective connecting terminals 152.

### TECHNICAL FIELD

The present invention relates to a lighting device for a display device, a display device, and a television receiver.

### BACKGROUND ART

A liquid crystal display device is a typical one of display devices with non-light-emitting optical elements. The display device includes a display panel, such as a liquid panel, and a backlight unit for emitting light to the display panel. The backlight unit is disposed behind the display panel (for example, see Patent Document 1).

### Patent Document 1: Japanese Unexamined Patent Application Publication No. 2006-19260

### Problem to be Solved by the Invention

The backlight unit disclosed in Patent Document 1 includes a configuration for parallel driving CCFLs. Specifically, Document 1 discloses a configuration including a plurality of cold cathode lamps, capacitors, and an inverter circuit. The cold cathode lamps are connected in parallel to each other. The capacitors are connected to the respective ends of the respective cold cathode lamps and equalize currents fed to the respective connecting terminals. The inverter circuit is connected to the capacitors and supplies drive power to the cold cathode lamp. With this configuration, the CCFLs can be parallel driven, and a uniform brightness can be provided. However, Document 1 does not disclose the positions of the capacitors relative to the respective cold cathode lamps. Document 1 merely discloses the configuration in which the capacitors are connected to the ends of the cold cathode tubes.

### DISCLOSURE OF THE INVENTION

An object of the present invention is to provide a lighting device for a display device with a narrower frame of the display device. Another object of the present invention is to provide a display device with such a lighting device for a display device. Still another object of the present invention is to provide a television receiver with such a display device.

### Problem to be Solved by the Invention

In order to solve the problem, a lighting device for a display device includes: a chassis; a plurality of discharge tubes disposed in parallel arrangement inside the chassis; an optical sheet disposed on an inner surface of the chassis, the optical sheet having an end portion in an arrangement direction in which the discharge tubes are arranged, the end portion bent along a bend line extending in a longitudinal direction of the discharge tubes; a power source configured to supply drive power for parallel driving the discharge tubes; a support member supporting ends of the discharge tubes; a plurality of connecting terminals arranged on the support member and in an arrangement direction in which the discharge tubes are disposed, the connecting terminals holding the discharge tubes individually and configured to function as terminals to supply the drive power to the respective discharge tubes; and a plurality of balancing components configured to balance currents of the drive power to be fed to the connecting terminals, the balancing components connected between the power source and the respective connecting terminals. The balancing components include an outer balancing component and inner balancing components that are other than the outer balancing component. The outer balancing component corresponds to outermost one of the connecting terminals in the arrangement direction and disposed on the support member and outer in the arrangement direction than the bend line. The inner balancing components are disposed on the support member and adjacent to the respective connecting terminals.

The balancing components of the lighting device for a display device balance the currents of the drive power to be fed to the respective connecting terminals. Because of this, the currents fed to the respective discharge tubes can be balanced (evened). Therefore, the common power source can parallel drive the plurality of discharge tubes.

Furthermore, the outer balancing component is disposed on the support member and outer in the arrangement direction of the discharge tubes than the bend line of the optical sheet. The inner balancing components are disposed on the support member and adjacent to the connecting terminal disposed closer to the center in the arrangement direction of the discharge tubes than the outermost connecting terminal. The lighting device for a display device has a frame area, which is a non-illumination area thereof. In comparison to the above, another configuration may be considered. The configuration includes a balancing component that is disposed outer in the arrangement direction of the discharge tubes than the outermost connecting terminal and closer to the center than the bend line of the optical sheet. When these two configurations are compared, the frame area of the lighting device according to the present invention is narrower than the frame area of the conceivable configuration. Therefore, a frame of the display device can be narrower. In addition, the support member may be a thin board.

The inner balancing components may be disposed adjacent to the respective connecting terminals and outer in the arrangement direction than the respective connecting terminals.

The balancing components are disposed outer in the arrangement direction of the discharge tubes than the respective connecting terminals. Because of this, no balancing component is disposed between two connecting terminals that hold two discharge tubes that are disposed adjacent to each other and the closest to the center in the arrangement direction of the discharge tubes. Therefore, the discharge tubes disposed closer to the center can be arranged at smaller intervals, or components other than the balancing components can be disposed on the center portion of the support member.

The lighting device for a display device according to the present invention may further include a power-source connector connected to the balancing components and to the power source for supplying the drive power. The power-source connector is disposed on the support member outer in the arrangement direction than the bend line, and adjacent to the outer balancing component in the longitudinal direction.

The power-source connector is disposed outer in the arrangement direction of the discharge tubes than the bend line of the optical sheet and adjacent to the outer balancing component in the longitudinal direction of the discharge tubes. The lighting device for a display device has the frame area, which is the non-illumination area thereof. In comparison to the above, another configuration may be considered. The configuration includes a power-source connector that is disposed between the outermost connecting terminal in the arrangement direction of the discharge tubes and the bend line of the optical sheet. When these two configurations are compared, the frame area of the lighting device according to the present invention is narrower. Therefore, the frame of the display device can be narrower.

The power-source connector may be disposed on the support member and closer to the center in the arrangement direction than the outermost one of the connecting terminals in the arrangement direction.

The power-source connector is disposed on the support member and closer to the center than the connecting terminal that holds the outermost one of the discharge tubes. Because of this, the frame area of the lighting device for a display device can be narrower. Therefore, the frame area of the display device can be narrower. In this case, the power-source connector may be disposed on the support member and closer to the center in the arrangement direction than one of the connecting terminals. The one of the connecting terminals is the closest to the center in the arrangement direction.

The lighting device for a display device may further include an insulating member. The support member is disposed inside the chassis. The support member has a surface opposite from the chassis. The balancing components and the connecting terminals that hold the discharge tubes are disposed on the surface of the support member. The power source is disposed outside the chassis. The insulating member is disposed between the chassis and the support member.

Because the insulating member is disposed between the support member and the chassis, the support member can be properly insulated from the chassis. Therefore, leakage of current to the chassis is prevented or reduced.

The support member may be disposed inside the chassis. The support member has a surface opposite from the chassis. The balancing components and the connecting terminals that hold the discharge tubes are disposed on the surface of the support member. The power source is disposed outside the chassis. The chassis has a portion covered by the support member. The portion has an opening.

Because the chassis has a portion covered by the support member, and the portion has the opening, the support member can be properly insulated from the chassis. Therefore, leakage of current to the chassis is prevented or reduced.

The chassis may be made of resin. The support member is disposed inside the chassis. The support member has a surface opposite from the chassis. The balancing components and the connecting terminals that hold the discharge tubes are disposed on the surface of the support member. The power source is disposed outside the chassis.

Because the chassis that houses the discharge tubes and the support member with the connecting terminals and the balancing components is made of resin, leakage of current from the components in the chassis to the chassis is suitably prevented or reduced.

Ferrules may be provided at ends of the respective discharge tubes and electrically connected to the respective connecting terminals.

The discharge tubes with such ferrules can establish electrical connection between the ferrules and the respective connecting terminals when the discharge tubes are attached to the respective connecting terminals. Namely, such discharge tubes having a simple configuration can contribute to a significant manufacturing cost reduction.

The discharge tubes may be cold cathode tubes. Because the cold cathode tubes can be thin, the lighting device for a display device with the cold cathode tubes as the light source can be thin. Therefore, the display device can be thin.

The balancing components may be capacitors. When parallel driving the discharge tubes, a uniform brightness is difficult to be achieved due to parasitic capacitances between the discharge tubes and the chassis. On contrary to this, according to the present invention, the capacitors having capacitances comparable to the respective parasitic capacitances and the like are connected between the power source and the respective connecting terminals. Therefore, a uniform brightness can be provided while parallel driving the discharge tubes.

The power source may include an inverter circuit configured to generate high-frequency voltage.

According to the present invention, the common power source can supply power to the plurality of discharge tubes. Because the common power source includes the inverter circuit for generating the high-frequency voltage, an inverter circuit is not required for each single one of the discharge tubes. Therefore, the configuration can be uncomplicated and suitable.

Next, in order to solve the above-described problem, a display device according to the present invention includes: a lighting device for a display device according to the present invention; and a display panel configured to provide display using light from the lighting device for a display device.

The lighting device for a display device has the narrower frame area, which is the non-illumination area thereof. Because the frame of the display device is narrower, the display device can be provided in a better design. Furthermore, a larger display area can be provided in the limited space.

The display panel may be a liquid crystal panel. Such a display device can be applied to various uses as a liquid crystal display device, for example, a television, a monitor for a personal computer. In particular, the display device is suitable for multi monitor management to use a plurality of display devices as monitors for a personal computer.

A television receiver according to the present invention includes the display device.

With this, the television receiver can be provided in a better design. Furthermore, a larger display area can be provided in the limited space.

### Advantageous Effect of the Invention

In accordance with the present invention, the lighting device for a display device can be provided with the configuration for parallel driving the discharge tubes for contributing to narrowing the frame of the display device can be provided. Furthermore, with such a lighting device for a display device, the display device with the narrower frame. Furthermore, with such a display device, the television receiver can be provided in the better design.

### BRIEF DESCRIPTION OF THE DRAWINGS

FIG. 1 is an exploded perspective view illustrating a schematic configuration of a television receiver;

FIG. 2 is an exploded perspective view illustrating a schematic configuration of a liquid crystal display device (a display device);

FIG. 3 is a sectional view along line A-A in FIG. 2;

FIG. 4 is a front view illustrating a main configuration of a backlight unit (a lighting device for a display device);

FIG. 5 is a front view illustrating a position of a frame in the backlight unit;

FIG. 6 is a back view illustrating a main configuration of the backlight unit;

FIG. 7 is a perspective view illustrating a configuration of a light-source holder;

FIG. 8 is an explanatory view schematically illustrating a configuration of a corner portion on a front side of the backlight device;

FIG. 9 is an explanatory view schematically illustrating a configuration of a lateral side portion on a front side of the backlight device;

FIG. 10 is an explanatory diagram illustrating a configuration for supplying drive power to cold cathode tubes;

FIG. 11 is an explanatory view schematically illustrating a configuration related to power supply;

FIG. 12 is a perspective view illustrating a configuration of a clip terminal;

FIG. 13 is a perspective view illustrating a configuration of one of the cold cathode tubes;

FIG. 14 is a plan view illustrating a configuration of a ferrule of the cold cathode tube;

FIG. 15 is a front view illustrating a state in which the clip terminal holds the cold cathode tube;

FIG. 16 is a plan view illustrating the state in which the clip terminal holds the cold cathode tube;

FIG. 17 is a perspective view illustrating a modification of the ferrule;

FIG. 18 is an explanatory view illustrating a configuration for insulating the clip terminal from the chassis;

FIG. 19 is an explanatory view illustrating a configuration for insulating the clip terminal from the chassis;

FIG. 20 is a front view illustrating a modification of the backlight device;

FIG. 21 is a front view illustrating a modification of an arrangement of a power-source connecting connector of the backlight device; and

FIG. 22 is an explanatory view illustrating a modification of an arrangement of ballast capacitors and the power-source connecting connector of the backlight device.

### EXPLANATION OF SYMBOLS

TV: television receiver
10: liquid crystal display device (display device)
11: display panel (liquid crystal panel)
12: backlight unit (lighting device for a display device)
14: chassis
14a: light reflection sheet (optical sheet)
14b: bend line
14c: opening edge
14d: optical member support portion (support surface)
17: cold cathode tube (discharge tube)
56: ballast capacitor (balancing component)
56a: ballast capacitor (outer balancing component)
56b: ballast capacitor (inner balancing component)
61: insulating board (insulating member)
62: opening
136: ferrule
151: support plate (support member)
152: clip terminal (connecting terminal)
158: power-source connecting connector (power-source connector)
170: power board (power source)

### BEST MODE FOR CARRYING OUT THE INVENTION

An embodiment according to the present invention will be described with reference to the drawings.

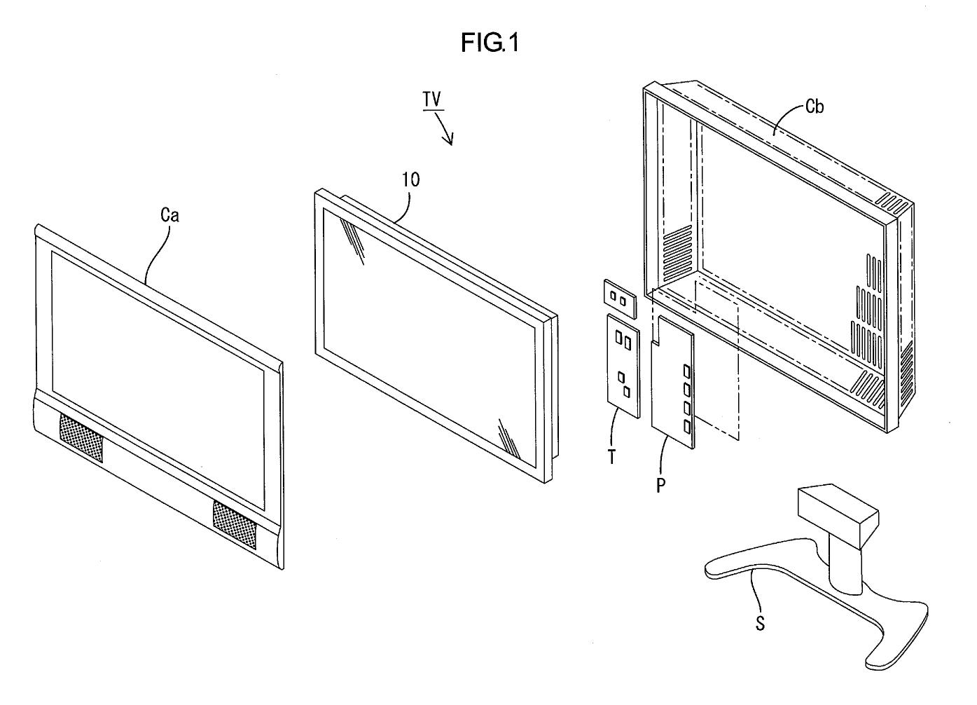

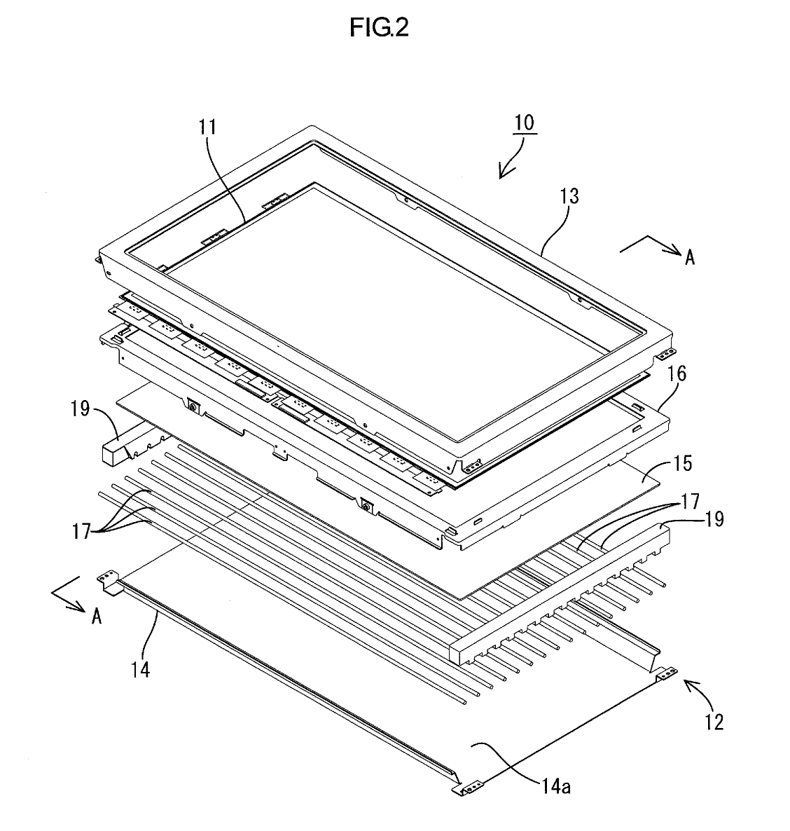

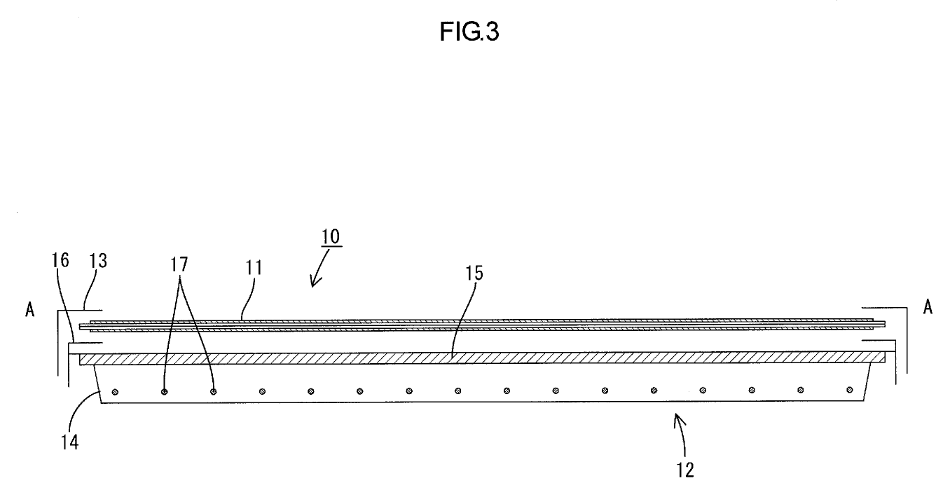

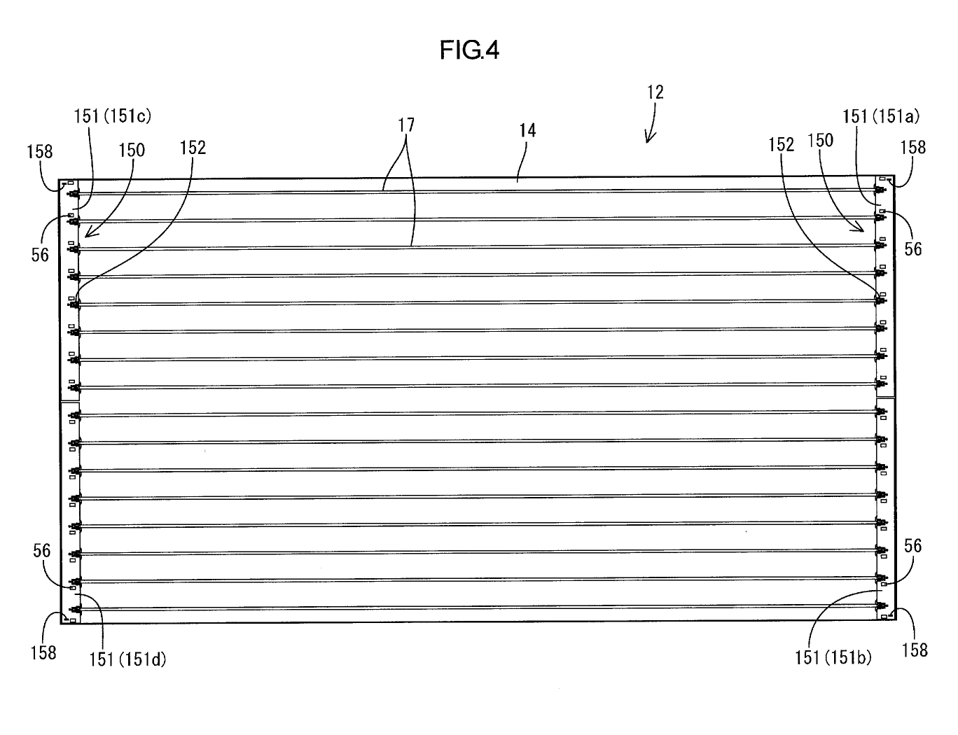

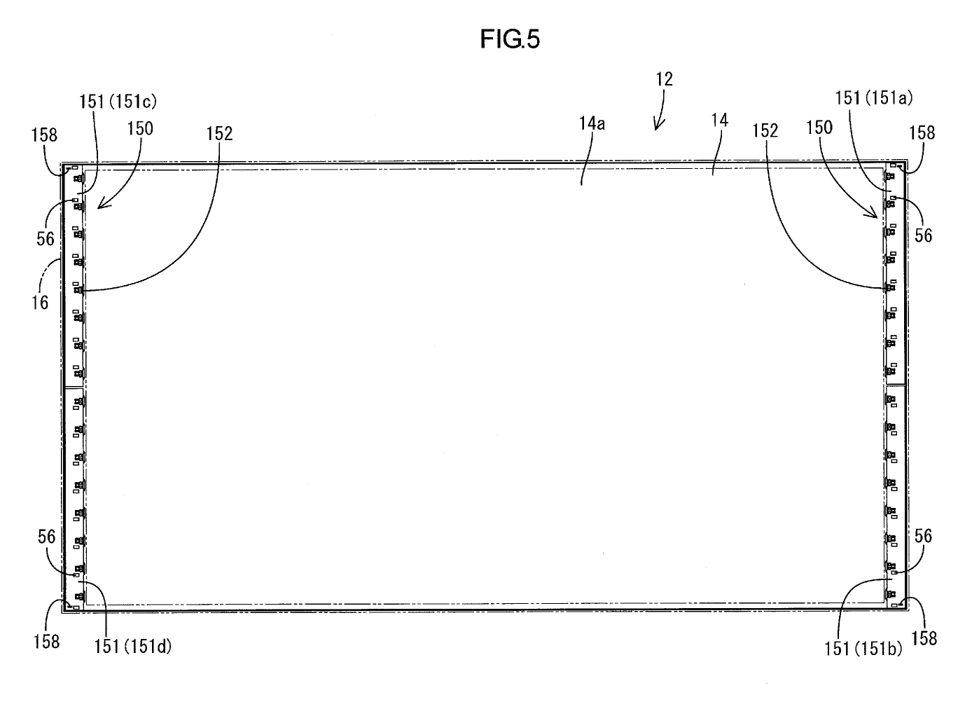

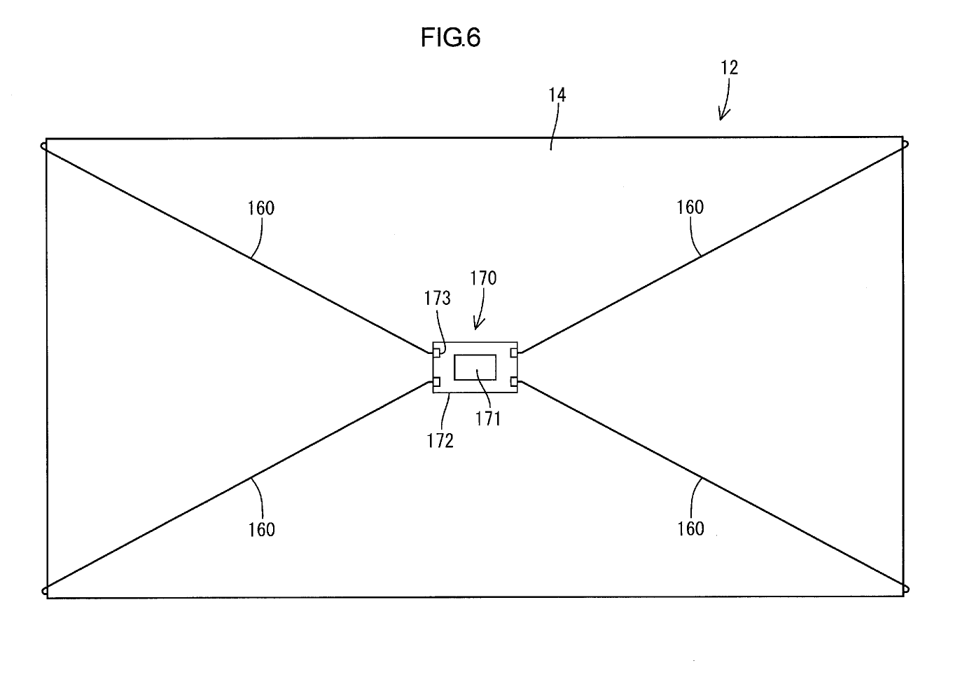

FIG. 1 is an exploded perspective view illustrating a schematic configuration of a television receiver TV of this embodiment. FIG. 2 is an exploded perspective view illustrating a schematic configuration of a liquid crystal display device (a display device) 10 of the television receiver TV. FIG. 3 is a sectional view along line A-A in FIG. 2. FIG. 4 is a front view illustrating a main configuration of a backlight unit 12 of the liquid crystal display device 10. FIG. 5 is a front view illustrating a position of a frame 16 in the backlight unit 12. FIG. 6 is a back view illustrating a main configuration of the backlight unit 12.

As illustrated in FIG. 1, the television receiver TV of this embodiment includes a liquid crystal display device (display device) 10, a front cabinet Ca, a back cabinet Cb, a power source P, a tuner T, and a stand S. The front cabinet Ca and the back cabinet Cb hold the liquid crystal display device 10 therebetween. The power source P is different from a below-described power board 170 (a power source of the present invention). The liquid crystal display device 10 has a landscape rectangular overall shape. As illustrated in FIG. 2, the liquid crystal display device 10 includes a liquid crystal panel 11 and the backlight unit (a lighting device for a display device) 12. The liquid crystal panel 11 is a display panel having a rectangular shape in planar view. The backlight unit 12 is an external light source. The liquid crystal panel 11 and the backlight unit 12 are held by a bezel 13 etc. in one piece.

The liquid crystal panel 11 has a known configuration, having a light transmissive TFT substrate and a light transmissive CF substrate with a predetermined gap therebetween and with liquid crystals (a liquid crystal layer) sealed between the substrates. The optical characteristics of the liquid crystal change according to a voltage applied thereto. The TFT substrate has an inner surface on which source lines and gate lines are arranged. The source line and the gate lines extend in the vertical direction and the horizontal direction, respectively, thereby forming a lattice pattern. The CF substrate has a color filter. The color filter includes color sections in three primary colors of read (R), green (G), and blue (B) in matrix arrangement. Each substrate has a surface disposed opposite from the liquid crystal side, and a polarizing plate is attached to the surface.

The backlight unit 12 is a so-called direct backlight unit, having a plurality of light sources directly facing the backside surface of the liquid crystal panel 11. The backlight unit 12 includes a chassis 14, a light reflection sheet 14a (an optical sheet), an optical member 15, the frame 16, a plurality of cold cathode tubes 17, and lamp holders 19. The front side (a light-exit side) of the chassis 14 is open. The light reflection sheet 14a is laid in the chassis 14. The optical member 15 is secured to the opening of the chassis 14. The frame 16 holds the optical member 15. The chassis 14 houses the cold cathode tubes 17. The lamp holders 19 block the light emitted from ends of the cold cathode tubes 17. The lamp holders 19 themselves have light reflectivity.

The cold cathode tubes 17 (discharge tubes) are linear light sources each emitting linear light. The optical member 15 converts the linear light to planar light. The optical member 15 also has a function of directing the planar light toward an effective display area of the liquid crystal panel 11 (i.e., directivity).

The chassis 14 is made of metal plate and has a rectangular shape in plan view. The chassis 14 has a substantial box-like shape with the front side (the light exit side) open. The light reflection sheet 14a is made of synthetic resin. The light reflection sheet 14a is a white member, having a high reflectivity. The light reflection sheet 14a is laid over the substantially entire area of an inner surface of the chassis 14. The light reflection sheet 14a is bent along the inner surface of the chassis 14 at the end portion (upper and lower end portions in FIG. 5) of the chassis 14 such that upper and lower end portions of the light reflection sheet 14a directs light toward the center. With the light reflection sheet 14a, most of the light emitted from the cold cathode tubes 17 is guided to the opening side of the chassis 14.

As illustrated in FIGS. 4 and 5, light-source holders 150 are provided in front (on the inner surface side) of the chassis 14. Each light-source holder 150 has clip terminals (connecting terminals) 152. The clip terminals 152 hold the respective ends of the respective cold cathode tubes 17. The clip terminals 152 are configured to supply drive power to the respective cold cathode tubes 17. The light-source holders 150 hold the cold cathode tubes 17 in parallel arrangement on the front side of the chassis 14. In this embodiment, the cold cathode tubes 17 are arranged at equal intervals.

As illustrated in FIG. 6, the power board 170 (a power source) is disposed behind the chassis 14. The power board 170 includes an inverter circuit for supplying the drive power to the cold cathode tubes 17 so as to parallel drive the cold cathode tubes 17. In this embodiment, a double-side driving method to supply power from the power board 170 (power source) to two sides of each cold cathode tube 17 is adopted. The configuration of supplying the drive power to the cold cathode tubes 17 and its functions will hereinafter be described.

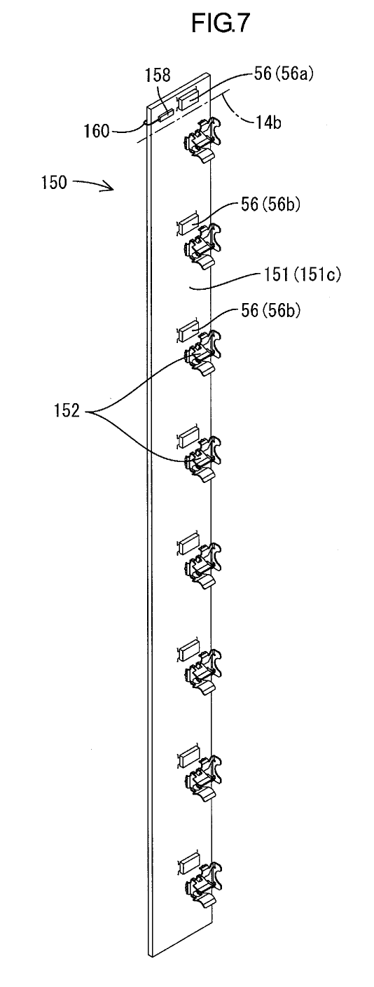

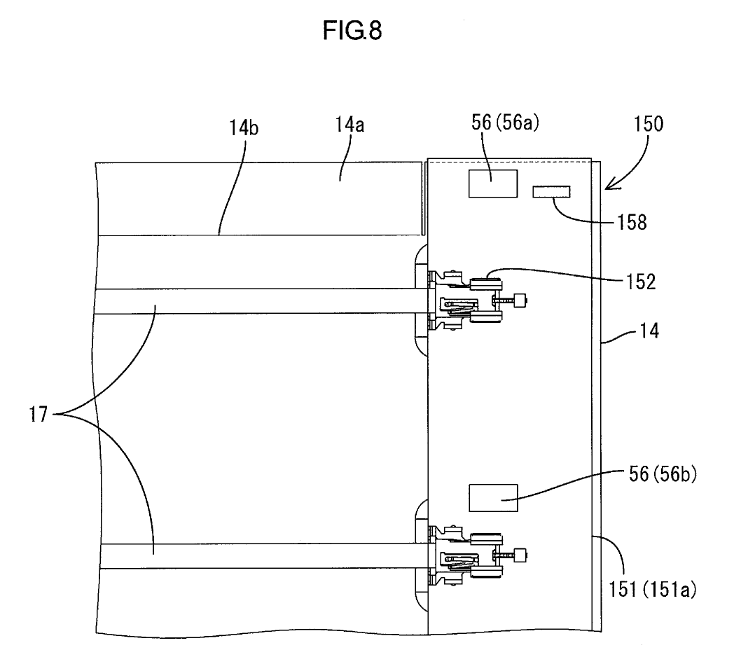

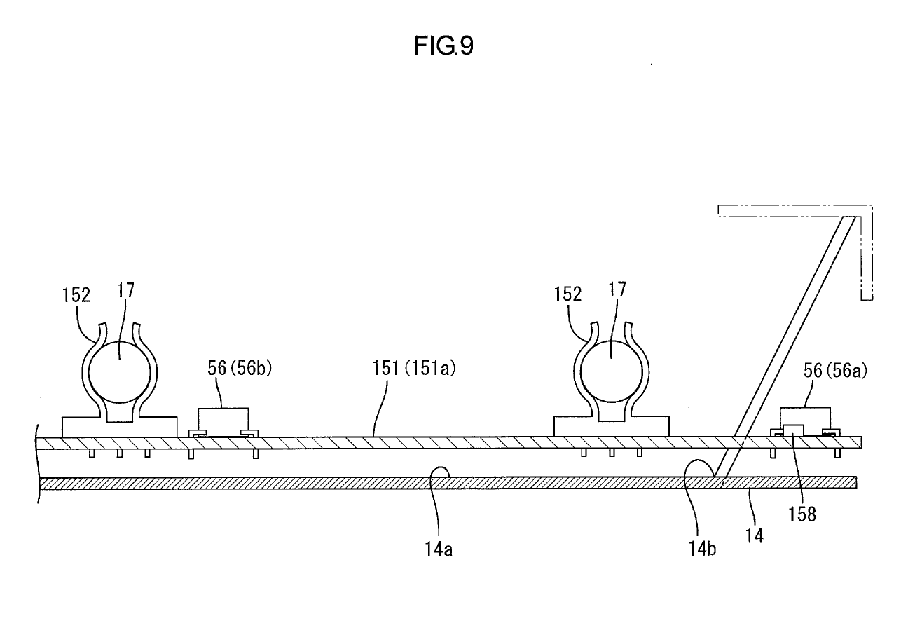

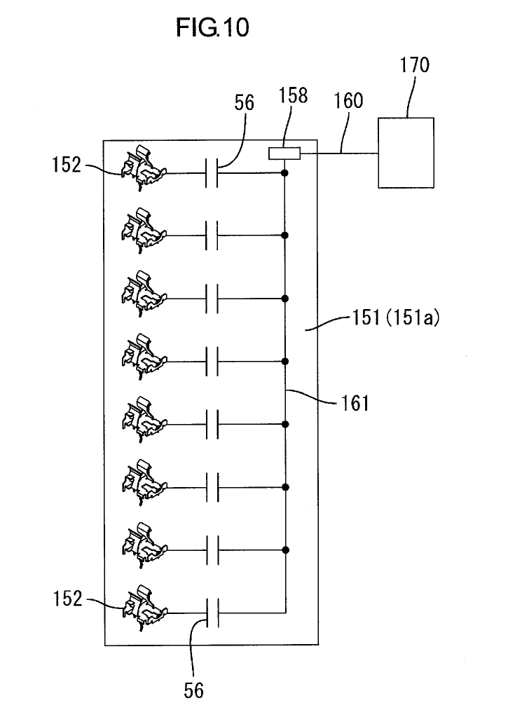

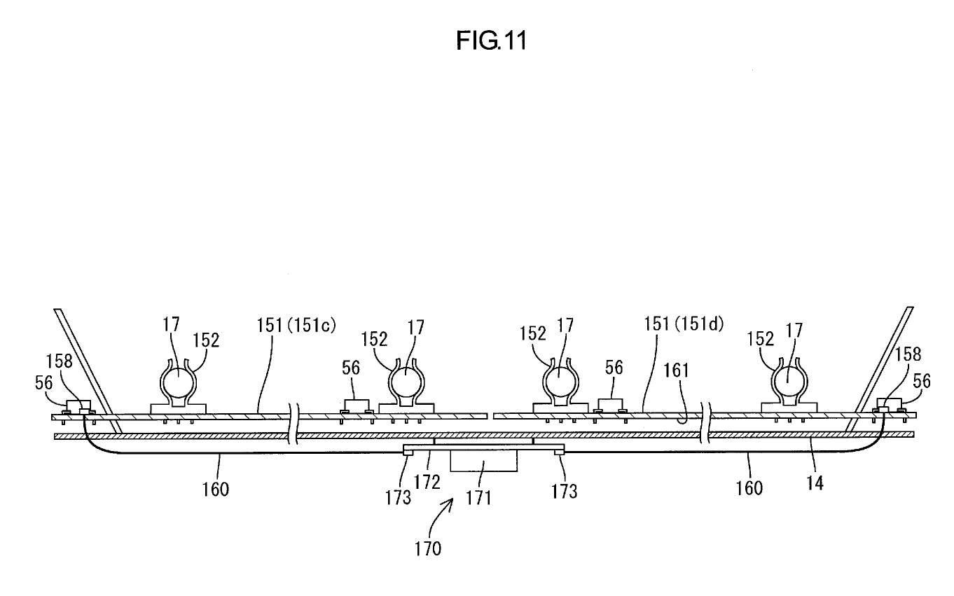

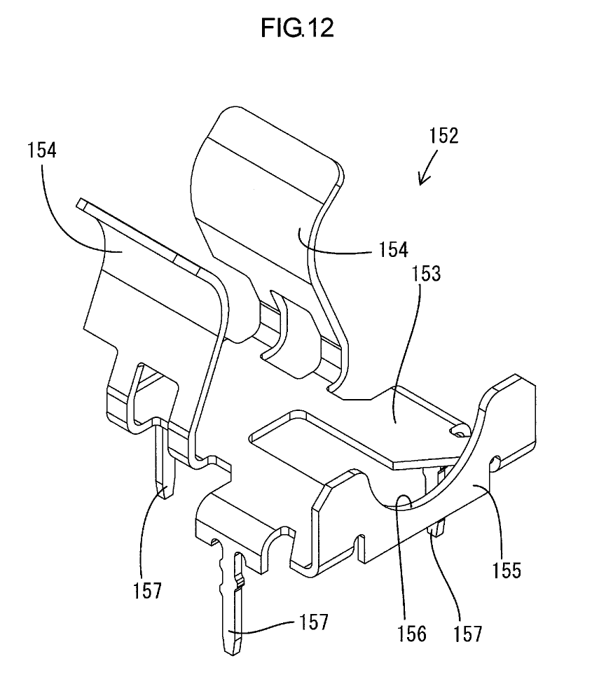

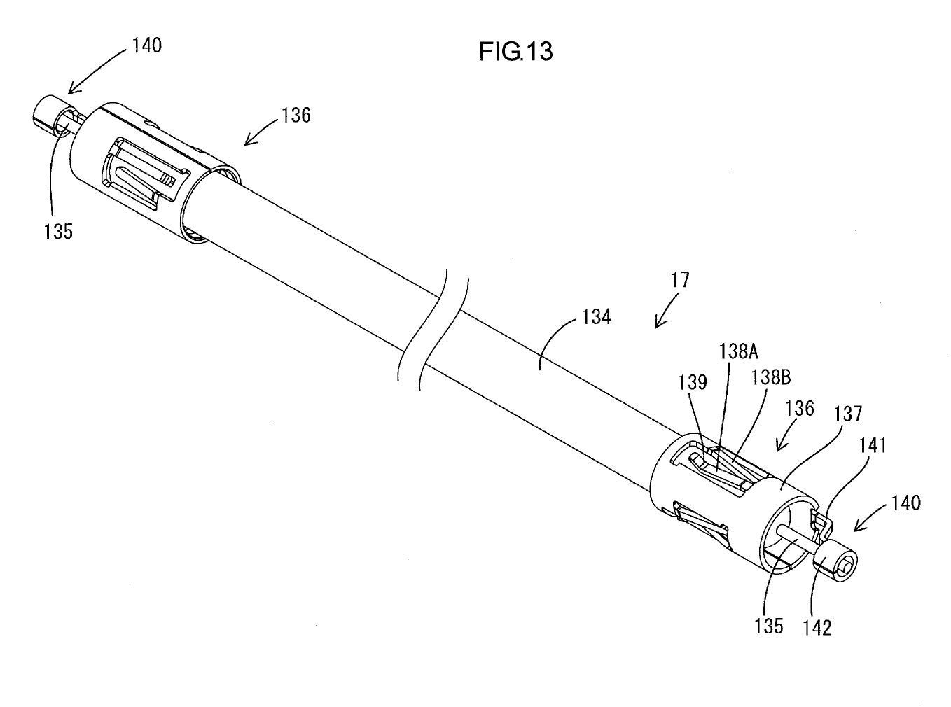

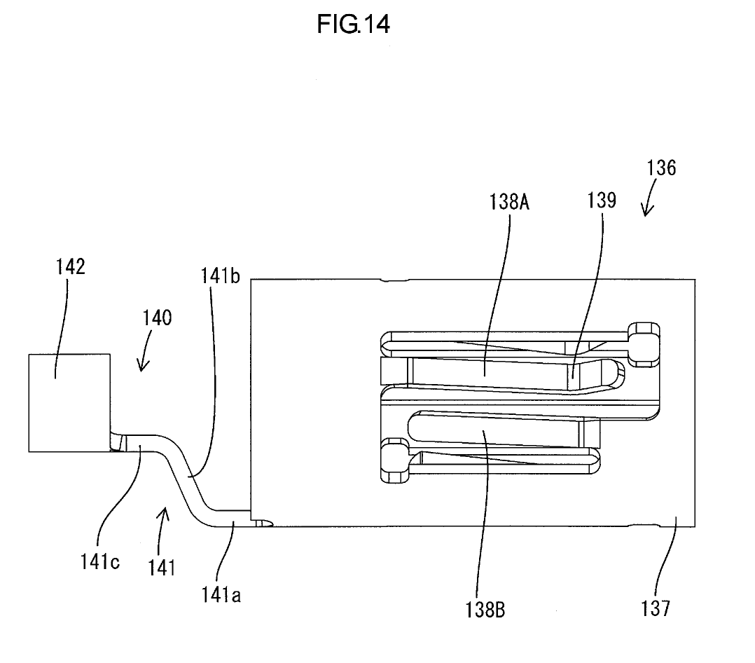

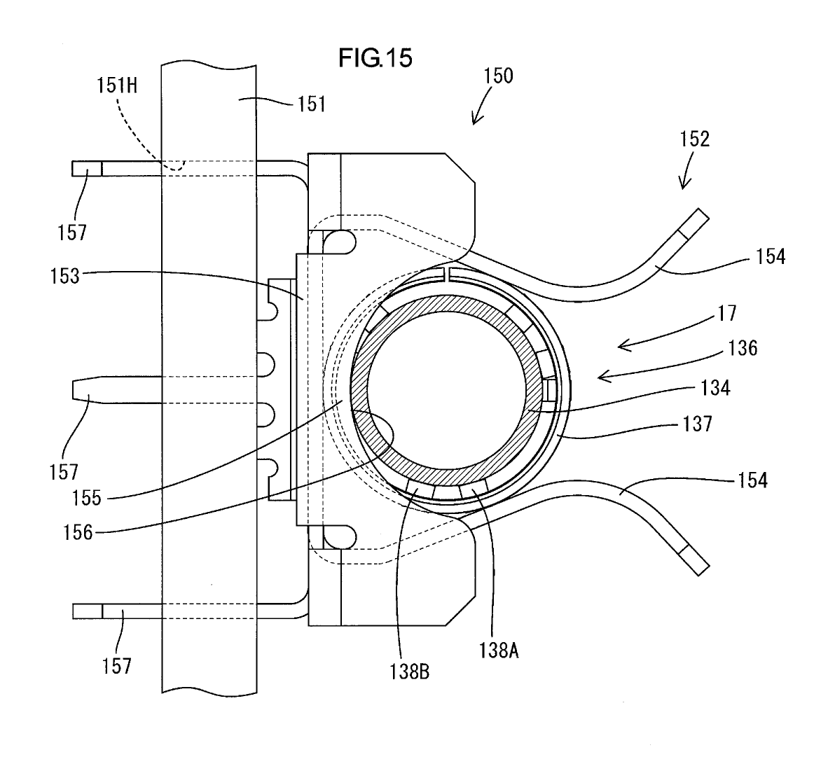

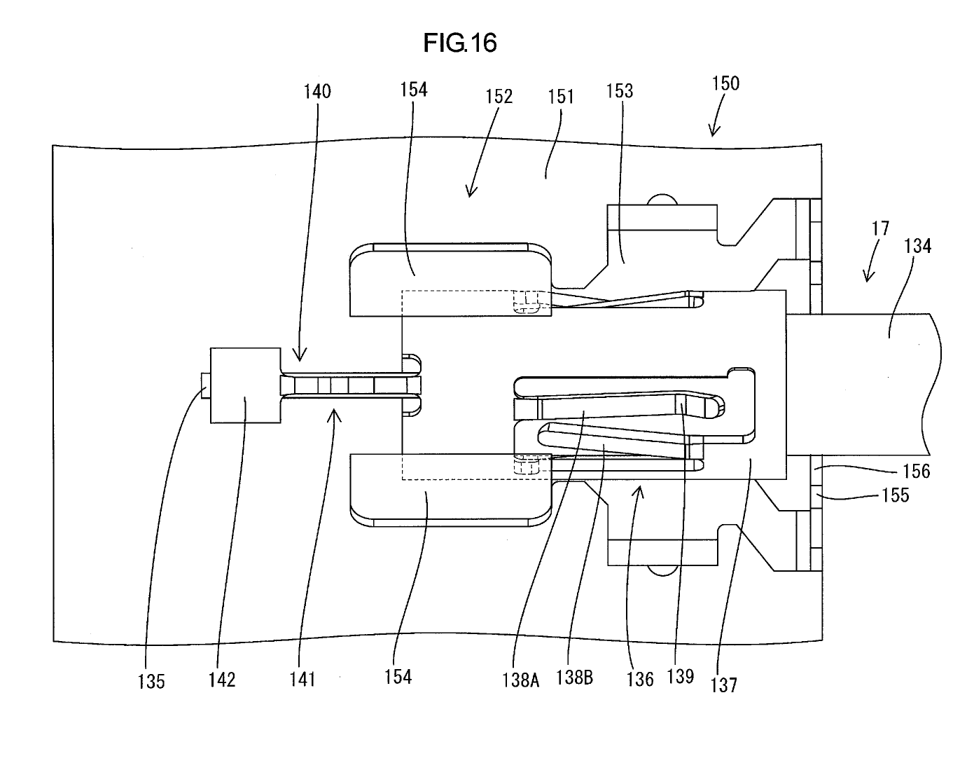

FIG. 7 is a perspective view illustrating a configuration of the light-source holder 150. FIG. 8 is an explanatory view schematically illustrating a configuration of a corner portion on a front side of the backlight unit 12. FIG. 9 is an explanatory view schematically illustrating a configuration of a lateral side portion on a front side of the backlight unit 12. FIG. 10 is an explanatory diagram illustrating a circuit configuration related to the power supply. FIG. 11 is an explanatory view schematically illustrating a configuration related to the power supply. FIG. 12 is a perspective view illustrating a configuration of one of the clip terminals 152. FIG. 13 is a perspective view illustrating a configuration of one of the cold cathode tubes 17. FIG. 14 is a plan view illustrating a configuration of a ferrule 136 of the cold cathode tube 17. FIG. 15 is a front view illustrating a state in which the clip terminal 152 is holding the cold cathode tube 17. FIG. 16 is a plan view illustrating the state in which the clip terminal 152 is holding the cold cathode tube 17.

Cold Cathode Tube 17

First, the configuration of the cold cathode tubes 17 will be described.

As illustrated in FIG. 13, each cold cathode tube 17 includes a glass tube 134, outer leads 135, and the ferrules 136. The glass tube 134 has a generally elongated linear shape with a round cross section. Each outer lead 135 projects from a corresponding end of the glass tube 134 linearly and coaxially with the glass tube 134. The outer lead 135 is made from metal (e.g. such as nickel-contained or cobalt-contained metal) and has an elongated and narrow shape with a round cross section. Each ferrule 136 is fitted onto the corresponding end of the glass tube 134. Mercury is sealed in the glass tube 134. Each end of the glass tube 134 has a substantially hemispherical shape, which is formed by hot melting. The outer lead 135 runs through the hemispherical portion.

As illustrated in FIG. 14, the ferrule 136 is an one-piece part. A piece of a metal plate (e.g. a stainless steel plate) is cut into a predefined shape and then shaped into the ferrule 136 by bending and hammering. The ferrule 136 includes a single body 137 and a single conductive piece 140. The body 137 has an overall cylindrical shape concentric with the glass tube 134. The body 137 has an inner diameter slightly greater than the outer diameter of the glass tube 134.

The body 137 is partially slit at circumferentially equal intervals, thereby forming three pairs of elastic holding pieces 138A, 138B.

The first elastic holding piece 138A, which is one elastic holding pieces 138A, 138B in each pair, extends generally backward (specifically, slightly radially inward or obliquely) in a cantilever fashion. The first elastic holding piece 138A can radially and elastically bend about a basal end (a front end) thereof as a fulcrum. An extending end portion (a rear end portion) of the first elastic holding piece 138A is turned radially outward or obliquely at a turned portion 139. The turned portion 139 has an outer surface with respect to the turn thereof (i.e. a surface which faces inward). The outer surface of the turned portion 139 is a contact point that abuts on an outer periphery of the glass tube 134. A virtual circle connecting these three first elastic holding pieces 138A is concentric with the body 137. When the first elastic holding pieces 138A are in a free state, that is, when they are not elastically bending, the virtual circle has a diameter smaller than the outer diameter of the glass tube 134.

The second elastic holding piece 138B, which is the other one of the elastic holding pieces 138A, 138B in each pair, is disposed circumferentially adjacent to the corresponding first elastic holding piece 138A. The second elastic holding piece 138B extends generally in a direction opposite from the extending direction of the first elastic holding piece 138A or frontward (specifically, slightly radially inward or obliquely) in a cantilever fashion. The second elastic holding piece 138B can radially and elastically bend about a basal end (a rear end) thereof as a fulcrum. An extending end of the second elastic holding piece 138B is a contact point that abuts on the outer periphery of the glass tube 134. A virtual circle connecting these three second elastic holding pieces 138B is concentric with the body 137. When the second elastic holding pieces 138B are in a free state, that is, when they are not elastically bending, the virtual circle has a diameter smaller than the outer diameter of the glass tube 134.

The conductive piece 140 extends frontward in a cantilever fashion from an end of the body 137. The conductive piece 140 includes a strip portion 141 and a cylindrical portion 142. The strip portion 141 is continuous with a front end of the body 137. The cylindrical portion 142 extends further frontward from a front end (an extending end) of the strip portion 141. The strip portion 141 includes a basal end portion 141a, a middle portion 141b, and a distal end portion 141c. The basal end portion 141a extends flush with the body 137 and parallel to the axis of the body 137. The middle portion 141b extends radially inward from an extending end of the basal end portion 141a toward the axis of the body 137. The distal end portion 141c extends parallel to the axis of the body 137 from an extending end of the middle portion 141b. The cylindrical portion 142 is continuous with an extending end of the distal end portion 141c. The strip portion 141 has a width sufficiently smaller than a length thereof. Therefore, the strip portion 141 elastically deforms in a radial direction of the body 137, in a direction crossing the radial direction of the body 137 (in a direction crossing the length of the strip portion 141), and torsionally around the axis of the strip portion 141 itself. The cylindrical portion 142 is formed by bending a portion that laterally spreads from the extending end of the strip portion 141 into a cylindrical shape with the axis substantially coaxial with the body 137. By elastically bending the strip portion 141, the cylindrical portion 142 can move in a direction around the axis of the ferrule 136 and in the radial direction of the ferrule 136.

Light-Source Holder 150

Next, the configuration of the light-source holders 150 will be described with reference to FIGS. 4 and 5. FIGS. 4 and 5 are front views of the backlight unit 12, wherein a schematic configuration of the light-source holders 150 is illustrated. In FIG. 5, the cold cathode tubes 17 are not shown.

Each light-source holder 150 has a function of holding the ends of the cold cathode tubes 17 to secure the cold cathode tubes 17 to the chassis 14. The light-source holder 150 includes elongated support plates (support members) 151, the clip terminals 152, and a plurality of ballast capacitors 56. The clip terminals 152 are arranged in line in front of the support plates 151. The ballast capacitors 56 are provided for balancing the currents of the drive power supplied to the respective clip terminals 152.

The support plates 151 include four plates (support plates 151a, 151b, 151c, 151d) made of a conductive material such as metal and disposed on the surface of the chassis 14. Specifically, two support plates 151 are secured to each of two lateral side areas of the surface of the chassis 14. Each support plate 151 has three securing holes H formed therethrough for each clip terminal 152 (see FIG. 15). The securing holes Hare holes in which the clip terminals 152 are fitted.

As illustrated in FIG. 12, a metal (e.g. nickel silver alloy) is cut into a desired shape and then is shaped into each clip terminal 152 by bending. The clip terminal 152 includes a base 153, a pair of elastic pressing pieces 154, and a stopper 155. The elastic pressing pieces 154 extend frontward in a vertically symmetrical fashion from respective upper and lower edge portions of the base 153. The base 153 has two opposed lateral sides. The stopper 155 extends frontward from one of the lateral sides of the base 153.

The elastic pressing pieces 154 are disposed on a side close to the other one of the lateral sides of the base 153. The elastic pressing pieces 154 have a bulged shape with parts thereof curved toward each other. The elastic pressing pieces 154 can elastically bend in a direction to increase the distance therebetween. When the elastic pressing pieces 154 are not elastically bending, the minimum distance between the elastic pressing pieces 154 is smaller than the outer diameter of the glass tube 134 of the cold cathode tube 17.

The stopper 155 upstands from the base 153 perpendicular to the axis of the cold cathode tube 17. The stopper 155 has a recess 156 of a substantially arcuate shape. The stopper 155 has areas upper than and lower than the recess 156. The upstanding measurement of these areas from the base 153 is as small as appropriate so as to reduce the metal material needed for the clip terminal 152.

Three legs 157 are formed integrally with the base 153. Two of the legs 157 protrude from the upper and lower edges of the base 153 between the elastic pressing pieces 154 and the stopper 155 backward, that is, in a direction opposite from the extending direction of the elastic pressing pieces 154 and the stopper 155. While the stopper 155 extends from the lateral side of the base 153 as described above, the other one of the legs 157 protrudes from a middle portion of a backside of the lateral side of the base 153 backward, that is, in a direction opposite from the extending direction of the elastic pressing pieces 154 and the stopper 155.

The clip terminals 152 are not covered by a housing or any other member made of synthetic resin. The bare clip terminals 152 are secured to the support plate 151 by soldering with the legs 157 being passed through respective securing holes 151H in the support plate 151.

The ballast capacitors 56 are balancing components and are provided corresponding to the respective clip terminals 152. All clip terminals 152 are provided with the respective ballast capacitors 56. The ballast capacitors 56 are connected in series to the respective clip terminals 152 (see FIG. 10). The ballast capacitors 56 are disposed on the support plate 151 adjacent to the respective clip terminals 152 and outer in the arrangement direction of the cold cathode tubes 17 than the respective clip terminals 152 (see FIG. 4). For example, the ballast capacitors 56 and the respective clip terminals 152 are arranged alternately on the support plate 151c that is disposed along the upper left side of the chassis 14 in FIG. 4 as follows. As illustrated in FIG. 7, the ballast capacitors 56 and the respective clip terminals 152 are arranged from an outer end portion (an upper end portion in the figure) toward the center-side end portion (a lower end portion in the figure) in the arrangement direction of the cold cathode tubes 17.

The support plate 151c is illustrated in FIG. 7. Similar to this, also on the other support plates 151a, 151b, and 151d, the ballast capacitors 56 are disposed adjacent to the respective clip terminals 152 and outer in the arrangement direction of the cold cathode tubes 17 than the respective clip terminals 152. The support plates 151a and 151b are vertically arranged along a right side portion of the chassis 14. As illustrated in FIGS. 4 and 5, the clip terminals 152 and the ballast capacitors 56 are arranged symmetrically with respect to a boundary line between the support plates 151a and 151b. The support plates 151c and 151d are vertically arranged along the left side portion of the chassis 14. The clip terminals 152 and the ballast capacitors 56 are arranged symmetrically with respect to a boundary line between the support plates 151c and 151d.

The light reflection sheet 14a is disposed along the inner surface of the chassis 14 as described above. As illustrated in FIGS. 8 and 9, the light reflection sheet 14a is bent along a bend line 14b. The bend line 14b extends in the longitudinal direction of the cold cathode tubes 17 in an area outer in the arrangement direction of the cold cathode tubes 17 than the outermost cold cathode tube 17. One of the ballast capacitors 56 (an outer balancing component 56a) is provided corresponding to the outermost clip terminal 152 in the arrangement direction of the cold cathode tubes 17. That ballast capacitor 56 is disposed on the support plate 151 and outer than the bend line 14b of the light reflection sheet 14a in the arrangement direction of the cold cathode tubes 17.

In FIGS. 8 and 9, only one corner (the upper right corner portion in FIG. 4) is illustrated. The configurations on the other (three) corner portions are similar to this. Namely, on each corner portion, one of the ballast capacitors 56a is provided corresponding to the outermost clip terminal 152 in the arrangement direction of the cold cathode tubes 17. The ballast capacitor 56a is disposed on the support plate 151 and outer than the bend line 14b of the light reflection sheet 14a in the arrangement direction of the cold cathode tubes 17.

The support plate 151 has an area closer to the center in the arrangement direction of the cold cathode tubes 17 than the outermost clip terminal 152. The other ballast capacitors 56 (inner balancing components 56b) are disposed on this area and, as described above, adjacent to the respective clip terminals 152.

These ballast capacitors 56 are connected in parallel to the power board (the power source) 170. More specifically, as illustrated in FIGS. 10 and 11, the ballast capacitors 56 are connected to a common line 161 that is formed on the back surface of each support plate 151. Through this common line 161, the ballast capacitors 56 are connected to a power-source connecting connector (a power-source connector) 158 provided on the outer end portion of each support plate 151 in the arrangement direction of the cold cathode tubes 17. The power-source connecting connector 158 is connected to a power supply line 160, and the power supply line 160 is connected to the power board 170.

As illustrated in FIGS. 8 and 9, the reflection sheet 14a of this embodiment has the bend line 14b. Each support plate 151 has the area outer in the arrangement direction of the cold cathode tubes 17 than the bend line 14b of the light reflection sheet 14a. The power-source connecting connector 158 is disposed adjacent to the ballast capacitor 56a and outer in the longitudinal direction of the cold cathode tubes 17 than the ballast capacitor 56a in the area of the support plate 151.

Power Board 170

As illustrated in FIG. 11, the power board 170 includes a circuit board 172, electronic components 171, and board connectors 173. A circuit is formed on a back surface (a surface opposite from the chassis 14) of the circuit board 172. The electronic components 171 are mounted to the back surface of the circuit board 172. The board connectors 173 are secured to the surface of the circuit board 172 closer to the chassis 14. The electronic components 171 include a transformer and other components. With these components, the circuit board 172 is configured as an inverter board that generates a high-frequency voltage. Each board connector 173 is disposed on an end portion of the circuit board 172 and is connected to the corresponding power-source connecting connector 158 via the corresponding power supply line 160. Each power-source connecting connector 158 is disposed on the corresponding support plate 151 in the chassis 14 as described above. The power board 170 is secured to the chassis 14 by screwing etc.

Attachment of Cold Cathode tube 17 to Clip Terminal 152

The manner of attaching each cold cathode tube 17 to the corresponding clip terminal 152 will now be described. The cold cathode tube 17 is held in the horizontal position and brought to the front of the chassis 14. Next, each end portion of the glass tube 134 and the ferrule 136 are forced into the space in the corresponding opposing pair of elastic pressing pieces 154 from the front (see FIGS. 15 and 16). The body 137 of the ferrule 136 then elastically bends the elastic pressing pieces 154 to open them. After the body 137 passes the narrowest space between the elastic pressing pieces 154, the elastic pressing pieces 154 forces the body 137 toward the base 153 by their elastically returning force until the body 137 comes into contact with the base 153. Thus, attachment of the cold cathode tube 17 is finished.

The cold cathode tube 17 in the attached state is supported at the ends thereof by the clip terminals 152. Because the pair of elastic pressing pieces 154 elastically contact the outer periphery of the body 137 of the corresponding ferrule 136, the outer lead 135 is conductively connected to the clip terminal 152 via the ferrule 136. Furthermore, the glass tube 134 is held against a wall of the recess 156 of the stopper 155 by the elastically returning force of the pair of elastic pressing pieces 154. Therefore, as viewed in the axial direction of the cold cathode tube 17, the body 137 partially overlaps the stopper 155. In other words, the end of the body 137 opposite from the conductive piece 140 is partially opposed to the stopper 155 with a little axial distance therebetween.

As described above, the television receiver TV of this embodiment includes the liquid crystal display device 10, which has the backlight unit 12 according to the present invention. The operational functions of this configuration will now be described.

The ballast capacitors 56 are disposed between the respective clip terminals 152 and the power board 170 to balance the currents of the drive power to be supplied to the respective clip terminals 152. Because of this, the currents fed to the respective cold cathode tubes 17 can be balanced (evened). Therefore, the common power board 170 can parallel drive the plurality of cold cathode tubes 17.

Furthermore, the ballast capacitor 56a (the outer balancing component) is provided corresponding to the outermost clip terminal 152 in the arrangement direction of the cold cathode tubes 17 on the support plate 151. The ballast capacitor 56a is disposed outer in the arrangement direction of the cold cathode tubes 17 than the bend line 14b of the light reflection sheet 14a. The other ballast capacitors 56b (the inner balancing components) are disposed on the support plate 151 and adjacent to the respective clip terminals 152 that are closer to the center than the outermost clip terminal 152 in the arrangement direction of the cold cathode tubes 17. The backlight unit 12 has a frame area, which is a non-illumination area thereof. In comparison to the above, another configuration may be considered. The configuration includes a ballast capacitor that is disposed between an outermost clip terminal and a bend line of an optical sheet in the arrangement direction of cold cathode tubes. When these two configurations are compared, the frame area of the backlight unit 12 is narrower.

Specifically, in the configuration in which the ballast capacitor is disposed on the support plate and between the clip terminal holding an outermost cold cathode tube in the arrangement direction of the cold cathode tubes and the bend line of the optical sheet, the quantity of light in the area in which the ballast capacitor is disposed is not enough. Therefore, the area is outside of the effective display area or the non-illumination area (the frame area). Because of this, the frame area of the backlight device has to include the area in which the ballast capacitor is disposed and the outside area, that is, the end portion of the light reflective sheet (the margin area that is outer than the bend line).

On contrary to this, in this embodiment, no ballast capacitor is disposed between the clip terminal 152 holding the outermost cold cathode tube 17 in the arrangement direction and the bend line 14b of the light reflection sheet 14a. In other words, the area in which the outermost ballast capacitor 56a overlaps the end portion of the light reflection sheet 14a. Because of this, as illustrated in FIGS. 5 and 9, the non-illumination area, which is covered by the frame 16, of the backlight unit 12 is narrower.

Thus, the frame area of the backlight unit 12 is narrower; therefore, the frame of the liquid crystal display device 10 is narrower.

Furthermore, in this embodiment, the power-source connecting connector 158 is disposed on the support plate 151, outer than the bend line 14b of the light reflection sheet 14a, adjacent to the ballast capacitor 56a (the outer balancing component), and outer in the longitudinal direction of the cold cathode tubes 17 than the ballast capacitor 56a. In comparison to the above, another configuration may be considered. The configuration includes a power-source connecting connector that is disposed between an outermost clip terminal in the arrangement direction of cold cathode tubes and a bend line of an optical sheet. When these two configurations are compared, the backlight unit 12 has the narrow frame area, which is the non-illumination area. Therefore, the frame area of the liquid crystal display device 10 can be narrower.

### Other Embodiments

The present invention is not limited to the above embodiments. For example, following configurations are also included within the scope of the present invention.

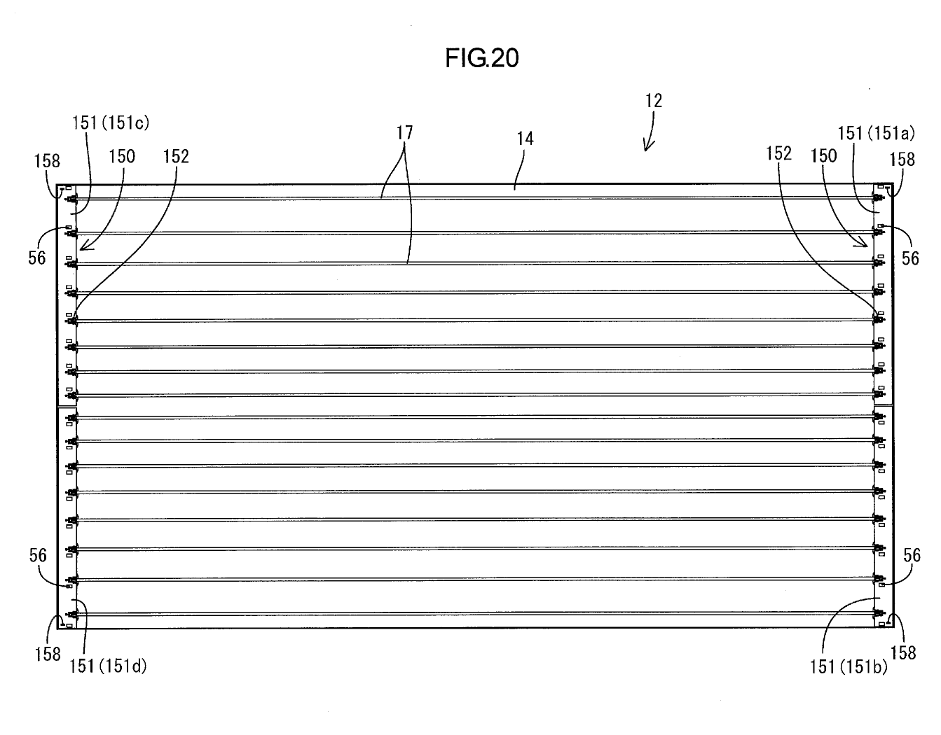

In the above-described embodiment, all of the cold cathode tubes 17 are disposed in equally spaced parallel arrangement. Instead of this, for example, as illustrated in FIG. 20, the cold cathode tubes 17 may be disposed in parallel arrangement at smaller intervals in one area and at larger intervals in another area (irregular pitch). In this case, similar to the above-described embodiment, the ballast capacitors 56 are disposed adjacent to the respective clip terminals 152 and outer in the arrangement direction of the cold cathode tubes 17 than the respective clip terminals 152. Because of this, no ballast capacitor 56 is disposed between the two clip terminals 152 holding two cold cathode tubes 17 that are adjacent to each other and the closest to the center in the arrangement direction of the cold cathode tubes 17 on the support member 151. Therefore, the cold cathode tubes 17 can be, for example, arranged at smaller intervals in a center area.

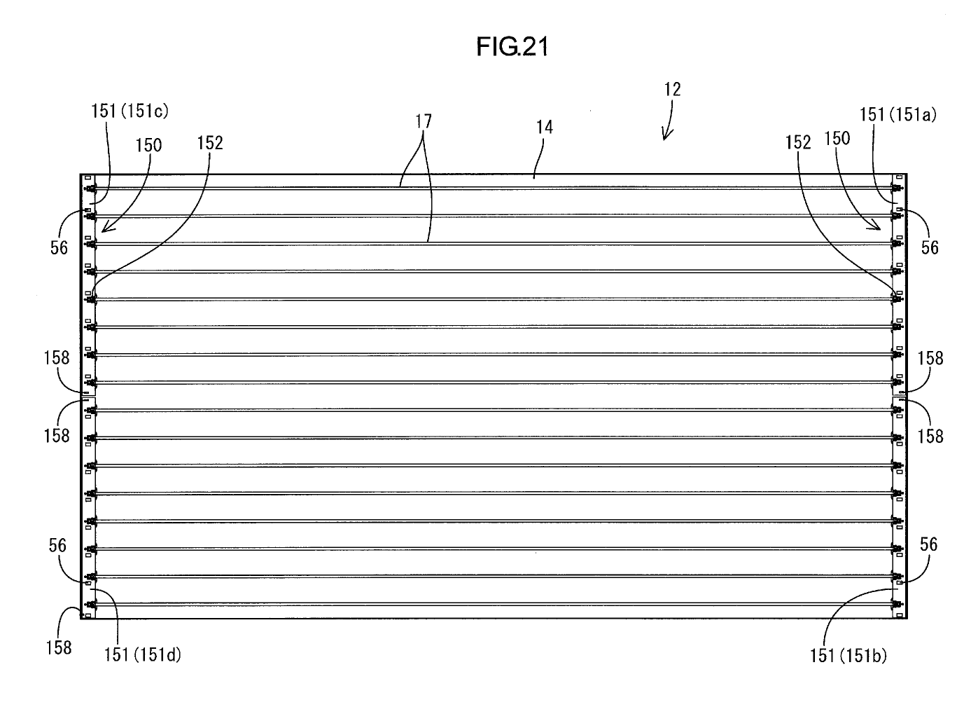

In the above-described embodiment, the power-source connecting connector 158 is disposed on each support plate 151 and in the area outer in the arrangement direction of the cold cathode tubes 17 than the bend line 14b of the light reflection sheet 14a. The position of the power-source connecting connector 158 on each support plate 151 is not limited to this. It is only necessary for the position of the power-source connecting connector 158 on the support plate 151 to be outside of the area between the outermost clip terminal 152 and the bend line 14b. Accordingly, for example, as illustrated in FIG. 21, the power-source connecting connector 158 may be disposed on the center-side end portion of each support plate 151 and closer to the center than a clip terminal 152 that is the closest to the center in the arrangement direction of the cold cathode tubes 17.

In the above-described embodiment, the ballast capacitors 56 are used as the balancing components. Instead of this, balance coils each having respective primary coils and secondary coils may be used. In this case, the primary coil of each balance coil is connected in series to the corresponding clip terminal 152 and in parallel with each other to the power board 170, while the secondary coils of all balance coils are connected in series to one another.

In the above-described embodiment, the parallel driven light sources are not limited to the cold cathode tubes. The light sources may be hot cathode tubes. Furthermore, the light reflection sheet 14a (the optical sheet) disposed on the inner surface of the chassis 14 may be a light reflective diffuser sheet that reflectively diffuses light.

In the above-described embodiment, two separate support plates 151 of the support plates 151a, 151b, 151c, and 151d are arranged in each side area of the chassis 14. However, a single support plate 151 may be provided on each side area of the chassis 14.

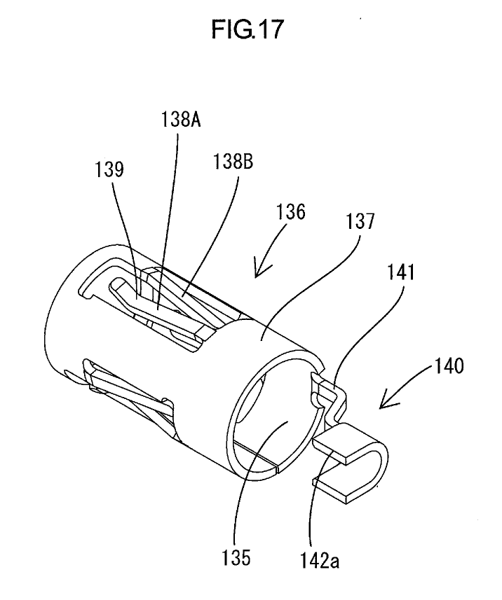

The ferrule may have a configuration illustrated in FIG. 17. Specifically, the cylindrical portion 142 of each ferrule 136 illustrated in FIGS. 13 and 14 may be replaced with a U-shaped cylindrical portion 142a. In this case, after the glass tube 134 is fitted in the ferrule 136, the U-shaped cylindrical portion 142a is bent along the outer lead 135, thereby electrically connecting the outer lead 135 and the cylindrical portion 142a. By bending the U-shaped cylindrical portion 142a, the electrical connection to the outer lead 135 can be improved.

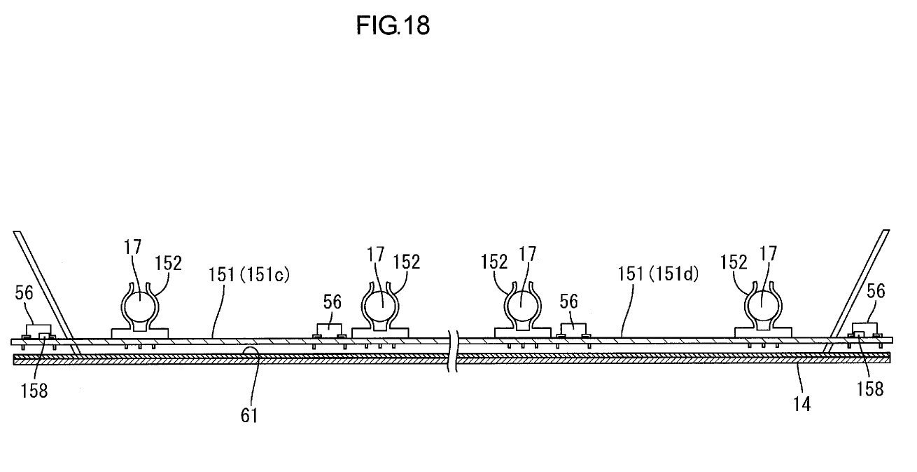

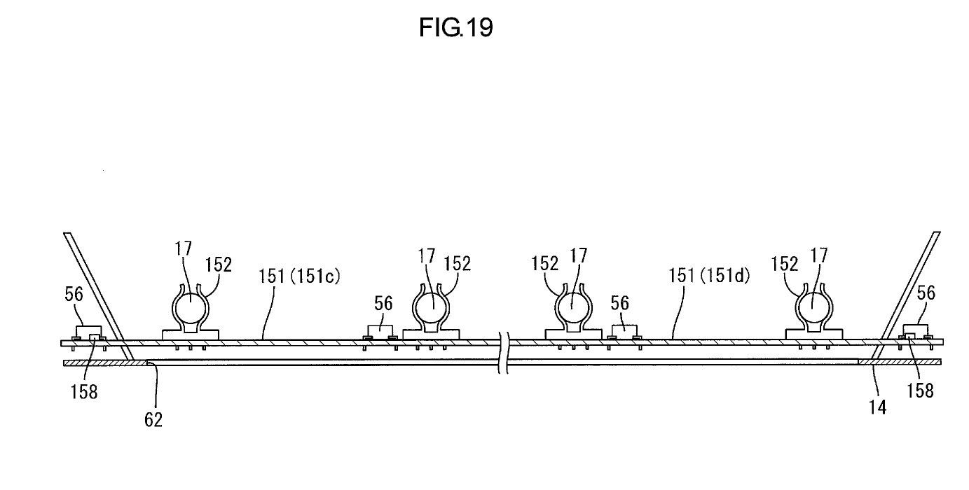

To provide insulation between the chassis 14 and the support plate 151, an insulating board (an insulating member) 61 may be disposed between the chassis 14 and the support plate 151 as illustrated in FIG. 18. Alternatively, the chassis 14 may have an opening 62 in a portion covered by the support plate 151 as illustrated in FIG. 19. Alternatively, the chassis 14 may be made of a resinous material.

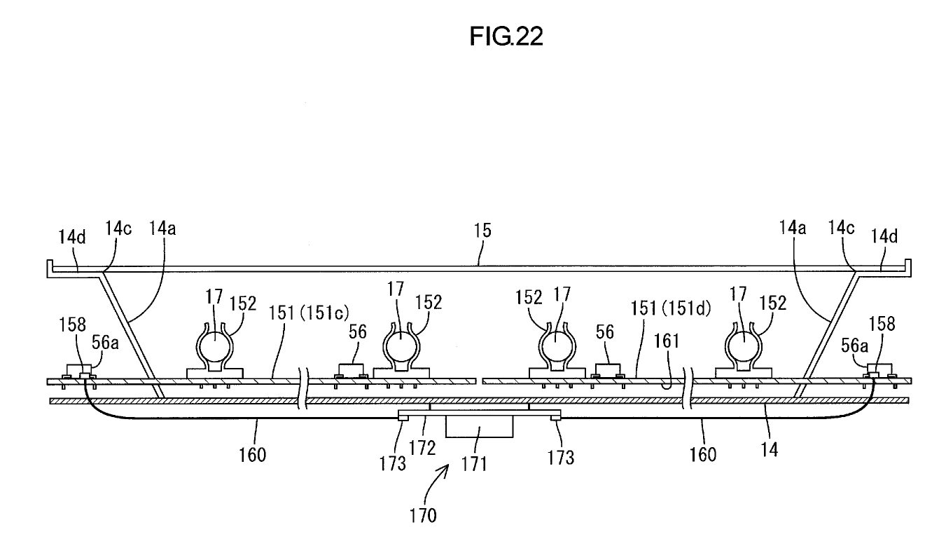

In the above-described embodiment, the ballast capacitor 56a (the outer balancing component) is provided on the support plate 151 and corresponding to the outermost clip terminal 152 in the arrangement direction of the cold cathode tubes 17. The ballast capacitor 56a is disposed outer in the arrangement direction of the cold cathode tubes 17 than the bend line 14b of the light reflection sheet 14a. The other ballast capacitors 56b (the inner balancing components) are disposed on the support plate 151 and adjacent to the respective clip terminals 152 that are disposed closer to the center than the outermost clip terminal 152 in the arrangement direction of the cold cathode tubes 17. The frame area is thus narrower. As illustrated in FIG. 22, for example, the ballast capacitor (the outer balancing component) 56a, which is provided corresponding to the outermost clip terminal 152 in the arrangement direction of the cold cathode tubes 17, may be disposed outer in the arrangement direction of the cold cathode tubes 17 than an opening edge 14c of the light reflection sheet 14a (the chassis 14).

Specifically, as illustrated in FIG. 22, the ballast capacitor (the outer balancing component) 56a and the power-source connecting connector (power-source connector) 158 may be disposed on an area that overlaps an optical-member support portion (a support surface) 14d that supports the optical member 15. The optical-member support portion (the support surface) 14d is an area that cannot supply light (light non-supply area) and therefore is covered by the frame 16 (see FIG. 2). The ballast capacitor (the outer balancing component) 56a and the power-source connecting connector (the power-source connector) 158 may create shadows. Because the ballast capacitor 56a and the power-source connecting connector 158 are disposed in the area covered by the frame 16, no shadows are created in a display area (a light supply area). Therefore, the frame area is still more suitably narrowed. In addition, in FIG. 22, the optical member 15 is illustratively placed on the optical-member support portion (the support surface) 14d, thereby positioning the optical member 15.

The switching components of the liquid crystal panel 11 in the liquid crystal display device 10 are not limited to the TFTs. The switching components may be MIMs (metal insulator metals). Moreover, the display device according to the present invention is not limited to the liquid crystal display device. The display device includes various display devices that need lighting devices behind the display panels.

1. A lighting device for a display device comprising:
a chassis;
a plurality of discharge tubes disposed in parallel arrangement inside the chassis;
an optical sheet disposed on an inner surface of the chassis, the optical sheet having an end portion in an arrangement direction in which the discharge tubes are arranged, the end portion being bent along a bend line extending in a longitudinal direction of the discharge tubes;
a power source configured to supply drive power for parallel driving the discharge tubes;
a support member supporting ends of the discharge tubes;
a plurality of connecting terminals arranged on the support member and in an arrangement direction in which the discharge tubes are disposed, the connecting terminals holding the discharge tubes individually and configured to function as terminals to supply the drive power to the respective discharge tubes; and
a plurality of balancing components configured to balance currents of the drive power to be fed to the connecting terminals, the balancing components connected between the power source and the respective connecting terminals,
the balancing components including an outer balancing component and inner balancing components that are other than the outer balancing component,
the outer balancing component corresponding to outermost one of the connecting terminals in the arrangement direction disposed on the support member and outer in the arrangement direction than the bend line, and
the inner balancing components being disposed on the support member and adjacent to the respective connecting terminals.

2. The lighting device for a display device according to claim 1, wherein the inner balancing components are disposed adjacent to the respective connecting terminals and outer in the arrangement direction than the respective connecting terminals.

3. The lighting device for a display device according to claim 1 further comprising a power-source connector connected to the balancing components and to the power source for supplying the drive power,
wherein the power-source connector is disposed on the support member outer in the arrangement direction than the bend line and adjacent to the outer balancing component in the longitudinal direction.

4. The lighting device for a display device according to claim 1 further comprising a power-source connector connected to the balancing components and to the power source for supplying the drive power,
wherein the power-source connector is disposed on the support member and closer to the center in the arrangement direction than the outermost one of the connecting terminals in the arrangement direction.

5. The lighting device for a display device according to claim 4, wherein the power-source connector is disposed on the support member and closer to the center in the arrangement direction than one of the connecting terminals, the one of the connecting terminals being the closest to the center in the arrangement direction.

6. The lighting device for a display device according to claim 1 further comprising an insulating member, wherein:
the support member is disposed inside the chassis;
the support member has a surface opposite from the chassis;
the balancing components and the connecting terminals that hold the discharge tubes are disposed on the surface of the support member;
the power source is disposed outside the chassis; and
the insulating member is disposed between the chassis and the support member.

7. The lighting device for a display device according to claim 1, wherein:
the support member is disposed inside the chassis;
the support member has a surface opposite from the chassis;
the balancing components and the connecting terminals that hold the discharge tubes are disposed on the surface of the support member;
the power source is disposed outside the chassis; and
the chassis has a portion covered by the support member, the portion having an opening.

8. The lighting device for a display device according to claim 1, wherein:
the chassis is made of resin;
the support member is disposed inside the chassis;
the support member has a surface opposite from the chassis;
the balancing components and the connecting terminals that hold the discharge tubes are disposed on the surface of the support member; and
the power source is disposed outside the chassis.

9. The lighting device for a display device according to claim 1 further comprising ferrules at ends of the respective discharge tubes, the ferrules being electrically connected to the respective connecting terminals.

10. The lighting device for a display device according to claim 1, wherein the discharge tubes are cold cathode tubes.

11. The lighting device for a display device according to claim 1, wherein the balancing components are capacitors.

12. The lighting device for a display device according to claim 1, wherein the power source includes an inverter circuit configured to generate a high-frequency voltage.

13. A display device comprising:
the lighting device for a display device according to claim 1; and
a display panel configured to provide display using light from the lighting device for a display device.

14. The display device according to claim 13, wherein the display panel is a liquid crystal panel with liquid crystals.

15. A television receiver comprising the display device according to claim 13.
